(19) United States
(12) Patent Application Publication
(10) Pub. No.: US 2008/0018943 A1
(43) Pub. Date: Jan. 24, 2008

(54) DIRECT ENGRAVING OF FLEXOGRAPHIC PRINTING PLATES

(75) Inventors: Ophir Eyal, Ramat Ha-Sharon (IL); Moshe Liberman, Rishon-LeZion (IL); Asaf Pellman, Pardes-Hanna (IL); Rina Rauchbach, Pardesia (IL); Haim Chayet, Nes Ziona (IL)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 11/424,919

(22) Filed: Jun. 19, 2006

(51) Int. Cl. B41C 1/04

(52) U.S. Cl. 358/3.29

(57) ABSTRACT

An optical imaging head for direct engraving of flexographic printing plates, comprising at least two laser diodes (10, 12) emitting radiation in one or more wavelengths; and means for imaging the one or more wavelengths of radiation at different depths relative to a surface of the plate.

### CROSS REFERENCE TO RELATED APPLICATIONS

Reference is made to commonly-assigned copending U.S. patent application Ser. No. 11/353,217, filed Feb. 13, 2006, entitled FLEXOGRAPHIC PRINTING PLATE PRECURSOR AND IMAGING METHOD, by Kimelblat et al., the disclosure of which is incorporated herein.

### FIELD OF THE INVENTION

This invention relates to an optical printing head and methods for direct engraving of sensitive flexographic printing plates by utilizing high power diode lasers.

### BACKGROUND OF THE INVENTION

Traditional flexographic printing methods prepare a printing plate by molding an elastomer such as rubber in a mold, or by photo-polymerizing a UV sensitive polymer. These methods are slow and expensive.

Another technique for creating a raised pattern on an elastomer surface is to directly cut the raised pattern using the well known NdYAG or CO₂ lasers, which are currently used as light sources in the direct engraving printing systems. The laser is controlled to ablate the elastomer in recessed areas and to leave the elastomer intact in raised areas. However, conventional flexographic printing plates cannot be laser engraved quickly. This is because the laser ablates a relatively thick layer (0.5 mm-2 mm) of elastomer. Thus, a multi KW laser is required to complete a typical flexographic plate in under one hour.

Another difficulty with previous attempts at laser engraving of flexographic printing surfaces with CO₂ lasers is that CO₂ lasers have a long wavelength, 10.6 microns, relative to the approximately 1 micron of the diodes lasers, which severely limits the resolution that can be achieved. In addition, due to their long wavelength of CO₂ laser, there is a need to use optical elements for the far infrared. These are quite expensive relative to optical elements that are used for the near infrared.

U.S. Pat. No. 6,150,629 (Sievers), describes a laser engraving system using two lasers with different wavelengths. Each laser can be modulated independently and temporally. The patent strictly talks of using temporal modulation to achieve different effects on the plate. The lasers are combined into one beam and imaged on the plate, using an external modulation acoustic optic modulator.

The Sievers methods have several disadvantages; including:

The different laser beams are focused to the same depth relative to the plate surface.

The different laser beams are combined into one common optical path.

External modulation using acousto optic modulators.

U.S. Pat. No. 4,947,023 (Minamida), describes an apparatus for roll dulling by pulse laser beam. The system utilizes a number of lasers emitting light at equal wavelengths; the lasers can be combined into one or more optical paths. The beam divergence of the lasers can be manipulated via beam expanders in order to get different spot sizes on the plate surface. The Minamida system does not use different wavelengths, or optical elements to spatially focus different wavelengths to different depths relative to the plate surface.

U.S. Pat. No. 6,664,498 (Forsman), describes a method and apparatus for increasing the material removal rate in laser machining. The intention of this patent, is to process materials, such as steel, aluminum, and silicon. There is no mention of printing plates. The main idea of the patent is to use high power pulsed lasers with bursts of very short laser pulses, usually with pulse duration in the nano second range. This objective cannot be achieved with fiber diodes.

### SUMMARY OF THE INVENTION

The present invention uses high power laser diodes and/or high power fiber coupled laser diodes, and/or laser fibers, instead of the well known powerful NdYAG and CO₂ lasers that are currently used as light sources in direct engraving printing systems. The multi-beam optical head of the present invention incorporates numerous laser diodes each having relative moderate powers, of the order of 10 Watts per emitter width of 100 micron, instead of using an optical head which has just one or two powerful beams of NdYAG and CO₂ lasers that emit hundreds of Watts.

The advantages of using diode lasers instead of NdYAG and CO₂ lasers are that diode lasers are compact, reliable and can be modulated directly at relative high frequencies without need for external modulators. Diode lasers are also available at different wavelengths and at high powers. No gas is used and relative low voltage is needed.

Laser diodes are now already available at relative high powers of approximately 10 Watts per emitter width of 100 micron. This enables using high power diode lasers for direct engraving of new types of relatively sensitive flexographic printing plates.

Direct engraving flexographic printing plates have general emissivity close to one and therefore absorb any wavelength. Laser light that impinges on the plate is absorbed by the plate, and engraves shaped holes in the plate. The present invention also includes several embodiments using optical heads and methods by which the laser light is controlled in order to enhance the direct engraving and ablating effect. For example, according to one aspect of the present invention the optical imaging head for direct engraving of flexographic printing plates comprises at least two laser diodes emitting radiation in one or more wavelengths, and means for imaging one or more wavelengths of radiation at different depths relative to a surface of the plate.

### BRIEF DESCRIPTION OF THE DRAWINGS

FIG. 1 is a schematic of one channel of a non-fiber optic system according to the present invention;

FIG. 2 is a schematic of one channel of a fiber coupled system according to the present invention;

FIG. 3 is a schematic of one channel of a non-fiber system using polarization beam combiners according to the present invention;

FIG. 4 is a schematic of one channel of a fiber coupled system using polarization beam combiners according to the present invention;

FIG. 5 is a ray trace and screen shots of spot sizes measured by two detectors;

FIG. 6 is a schematic of one channel for a serial exposure mode according to the present invention;

FIG. 7 is a schematic of one channel using two diodes having the same wavelength with fiber optics having different dimensions;

FIG. 8 is a schematic of the embodiment shown in FIG. 7 using diodes which emit at different wavelengths;

FIG. 9 is a schematic of one channel of the present invention with the distal end of the fibers arranged in different object planes;

FIG. 10 is a schematic of a system for measuring the relative shift in the image plane V, versus the fiber position in the object plane U;

FIG. 11 is a graph showing relative shift in image plane versus fiber position U, in the object plane;

FIG. 12 is an embodiment of the present invention incorporating a glass plate of thickness D and index of refraction n;

FIG. 13 is an embodiment of the present invention incorporating a glass plate constructed from several zones, each having a different thickness and different or same index of refraction;

FIG. 14 is an embodiment of the present invention incorporating a glass plate which has a variable profile of the index of refraction along the Y direction;

FIG. 15 is a schematic showing an embodiment for confocal and auto-focus measurements useful in a diagnostics system;

FIG. 16 shows conversion of a Gaussian beam profile to two types of top hat profiles by using diffractive elements;

FIG. 17 shows a cross-section of a specific case where optical fibers are aligned in two V-grooves; and

FIG. 18 is an expanded view of one of the V-grooves shown in FIG. 17.

### DETAILED DESCRIPTION OF THE INVENTION

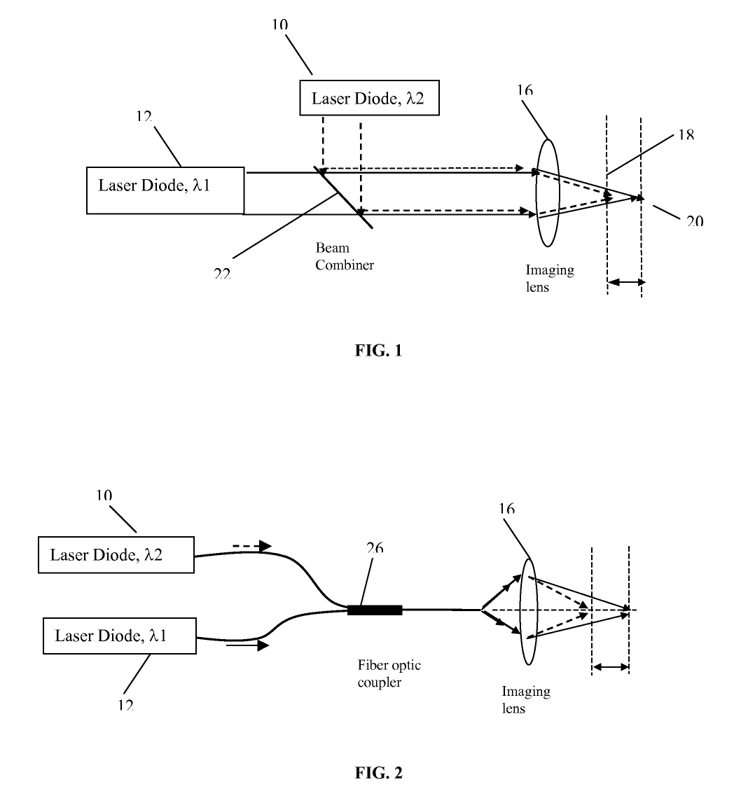

The present invention suggests several methods by which the laser diode light is controlled in order to enhance the direct engraving and ablating effect. Referring to FIG. 1, the invention is described by the schemes shown for the specific case of two laser diodes 10, 12 that emit in two different wavelengths. By using laser diodes which emit at different wavelengths, and by controlling the dispersion of the imaging lens 16, the focus points 18, 20 at the different wavelengths will be shifted one relative to each other.

FIG. 2 describes the same idea as FIG. 1 for the case of fiber coupled diodes. The two different wavelengths are combined into one fiber using a fiber optic coupler 26 instead of the beam combiner 22.

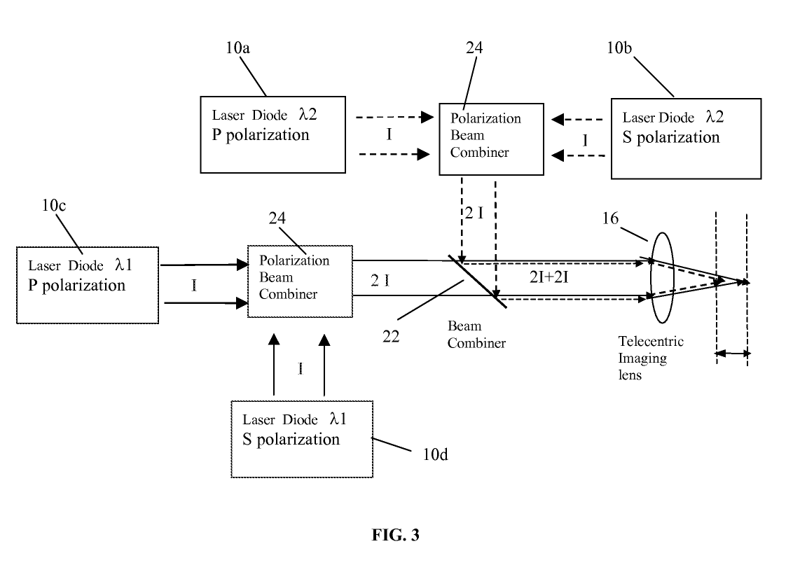

The light emitted from laser diodes is highly polarized. Therefore, by using a polarization beam combiner 24, shown in FIG. 3, the power of two diodes that emit the same wavelength 10a, 10b can be combined into one path. Doing so the power of each wavelength is doubled and the overall power that impinges on the plate can be increased by four times. Polarization beam combiners are well known elements used in the optical field to couple light sources that have different configurations. Polarization beam combiners are available in both free space and fiber (mainly for single mode fibers) coupled configurations.

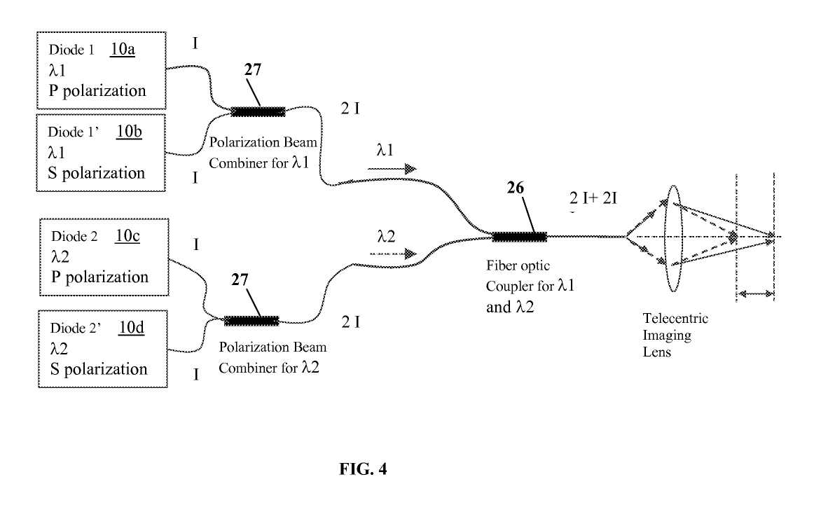

FIG. 4 shows the same general concept as FIG. 3 for the case of fiber coupled diodes in an embodiment using two different wavelengths. The power of two fiber coupled diodes that emit the same wavelength 10a, 10b is first combined into one fiber by using a polarization fiber-optic combiner 27. Two additional diodes 10c, 10d, which emit a second wavelength are combined into one path.

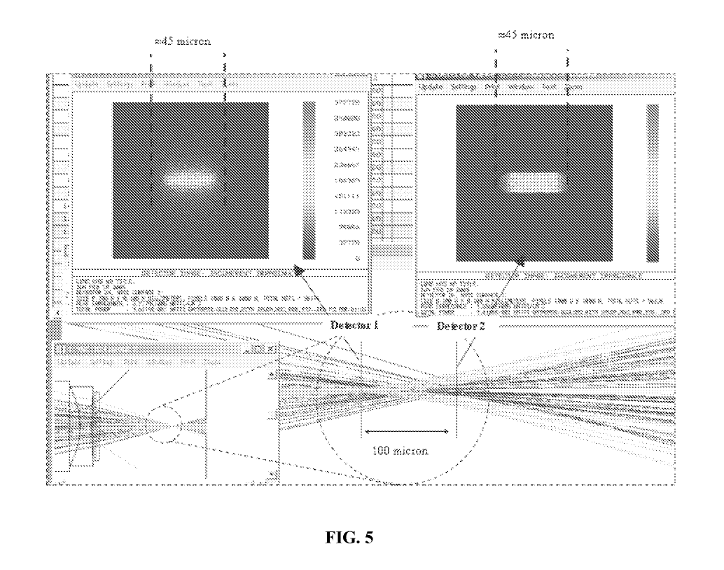

In order to roughly check and present the concept a simulation, shown in FIG. 5, using a specific imaging lens and two diodes which emit at 800 nm and 970 nm, was carried out. The results show the ray trace and the spot size as measured by two detectors. The detectors are located at the two focal points, which are shifted in approximately 100 micron relative to each other. The imaging lens can of course be designed in order to achieve a desired shift.

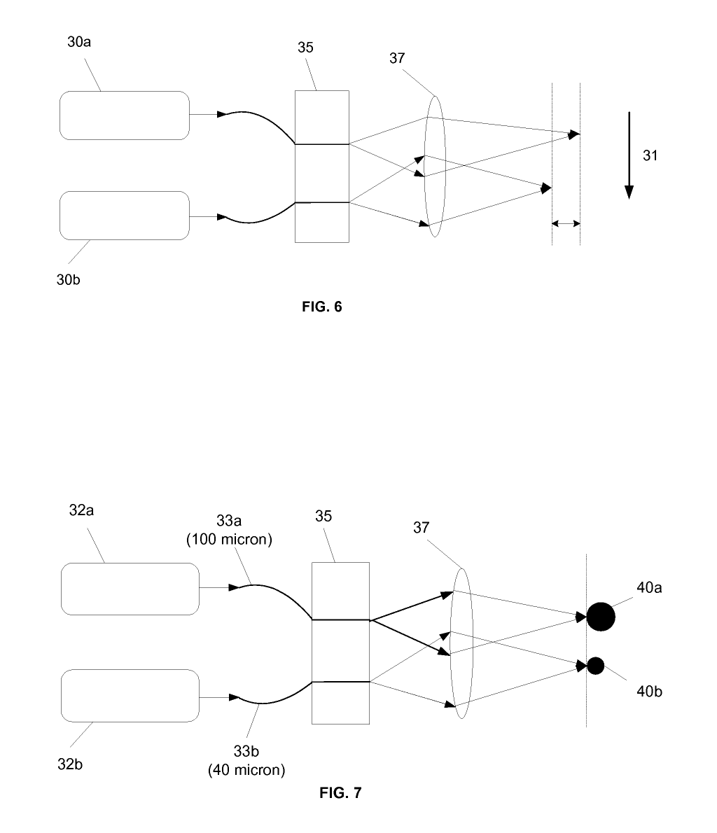

FIG. 6 shows laser diodes 30a, 30b with different wavelengths located adjacent to each other. In general, the optical head (not shown) moves along the plate, in the direction indicated by arrow 31. First, laser diode 30b is activated and just then the laser diode 30a, i.e. when it reached the same pixel which was already exposed by laser diode 30b. The embodiment described uses fiber coupled diodes. The description is just for two out of n channels. The same general idea can of course be implemented, with no fibers.

Optical fibers 33a and 33b with different core diameters can be assembled on the same V-groove 35, as shown in FIG. 7. This can be implemented for the same or different wavelengths. This way, by using only one imaging lens 37 one can get spots of two sizes. The figures show an example for two laser diodes 32a and 32b of the same wavelength. If optical fiber 33b is a 40 micron fiber and optical fiber 33a is a 100 micron fiber, then by using a 1×2 imaging lens 37 one gets a 20 micron spot 40b and a 50 micron spot 40a.

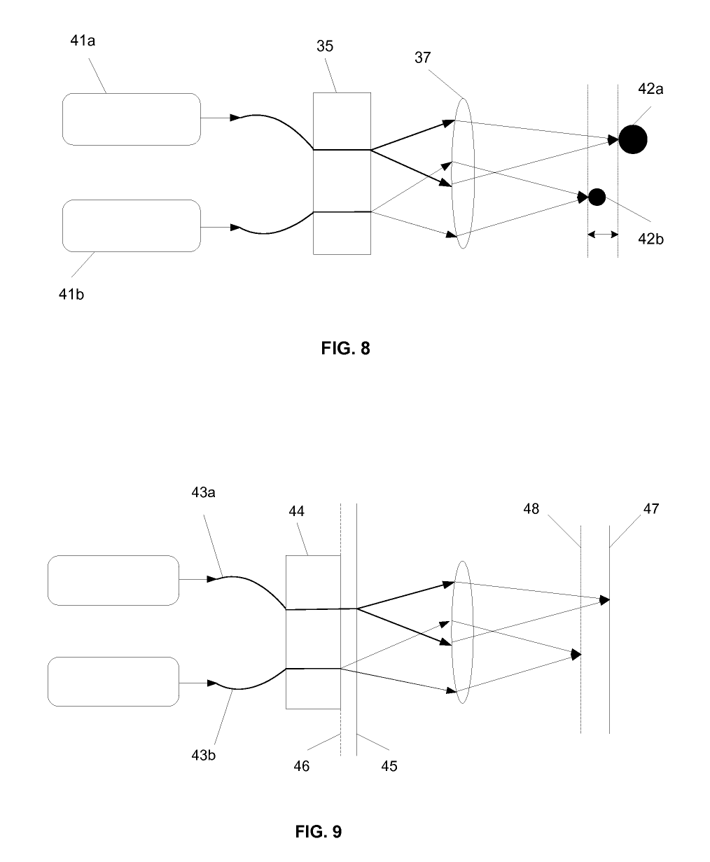

FIG. 8 shows the same concept, but now the laser diodes 41a and 41b emit at different wavelengths. Spots of different diameters 42a and 42b respectively are achieved at different locations.

In FIG. 9, the distal tips of optical fibers 43a and 43b are assembled in the V-groove 44 in different object planes 45 and 46 respectively relative to each other. As a result, the image planes 47 and 48 of the different fiber tips respectively will be shifted one relative to the other. FIG. 9 shows the effect just for two fibers. The optical fibers can be identical, or different, for example with different core diameters. Fibers can emit radiation at the same or different wavelengths.

In any one of the embodiments of FIGS. 6 through 9, the optical radiation guided in the fiber can be in a filled or an underfilled state. In general, the laser diodes can be temporally modulated relative to each other in order to get different effects on the direct engraving plate.

FIG. 10 describes an example of a specific measurement system in which the image position shift was measured.

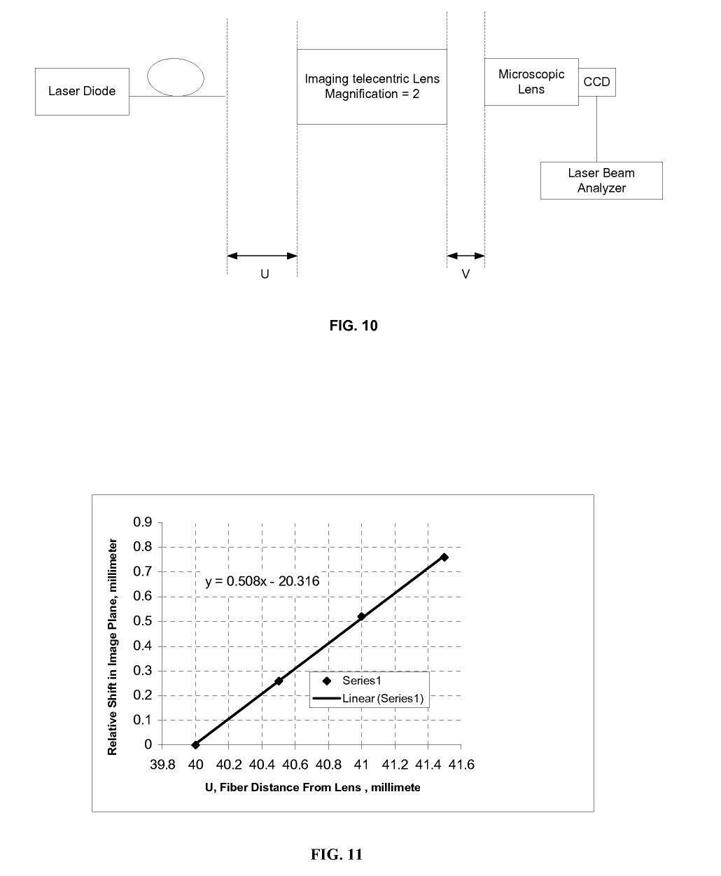

The graph in FIG. 11 shows the relative shift in the image position as a function of the position U, of the distal tip of the fiber, as measured by the system of FIG. 10. The shift in image position V, was found by moving the position of the microscope lens in order to find the smallest spot. A laser beam analyzer was used to measure and define a spot that includes 95% of the laser beam energy.

For this specific case of using a telecentric imaging lens with a magnification of 2, it can be seen that moving the distal tip of the fiber in the object plane X mm results in a shift of 0.508 X mm in the image position. For example, moving the distal tip of the fiber 0.2 mm, from U=40 to U=40.2, causes the image to move by an absolute relative distance of 0.1 mm.

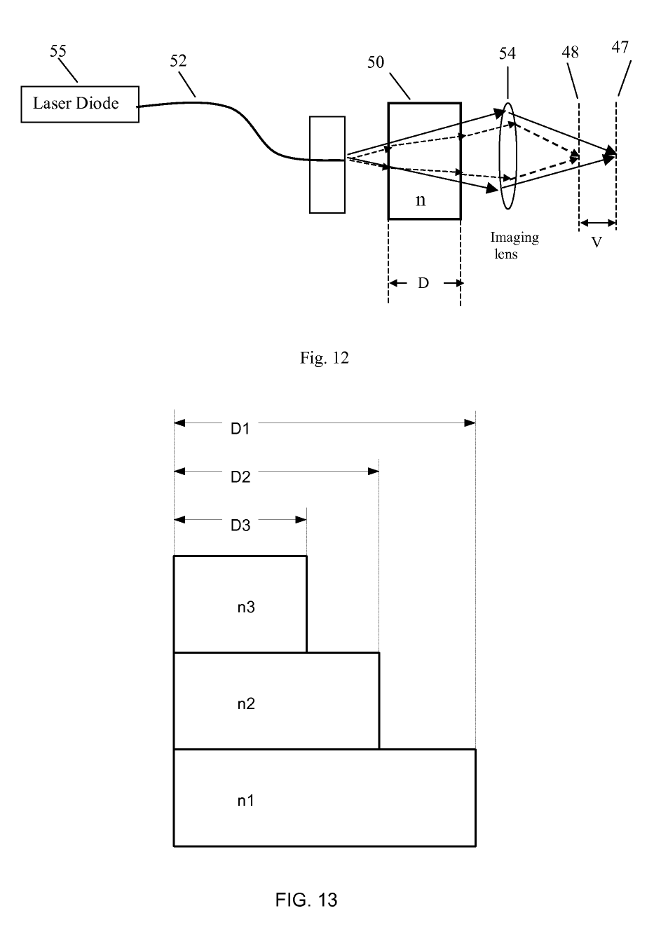

As shown in FIG. 12, a glass plate 50 of thickness D placed between the distal tip of the fiber 52 and the imaging lens 54, will cause the image plane to shift from image plane 47 to 48. The shift V in the position of the image plane is a function of the thickness D of the plate and its index of refraction n. The schematic presents the effect of such a glass plate for the specific case of a single laser diode 55. The solid rays describe the case when no plate is used and in which the rays are focused in image plane 47. The dashed rays describe the case when a plate is used and in which the focus is shifted to image plane 48. When a multi laser source constructed from different wavelengths is used the shift V will be a function of the wavelength due to the fact that the index of refraction n, is a function of the wavelength.

The glass plate can be constructed from several zones, each having a different thickness and different or same index of refraction as depicted in FIG. 13. Such a structure enables moving and adjusting the glass plate in front of the fiber tips in order to get a required shift.

The glass plate can also have a variable profile of the index of refraction that changes along the Y direction. This form of the glass plate is shown in FIG. 14. Such a structure enables to move and adjust the right zone of the glass plate in front of the fiber tips in order to get a required shift. The glass plate may also be inserted between the imaging lens and the imaged surface.

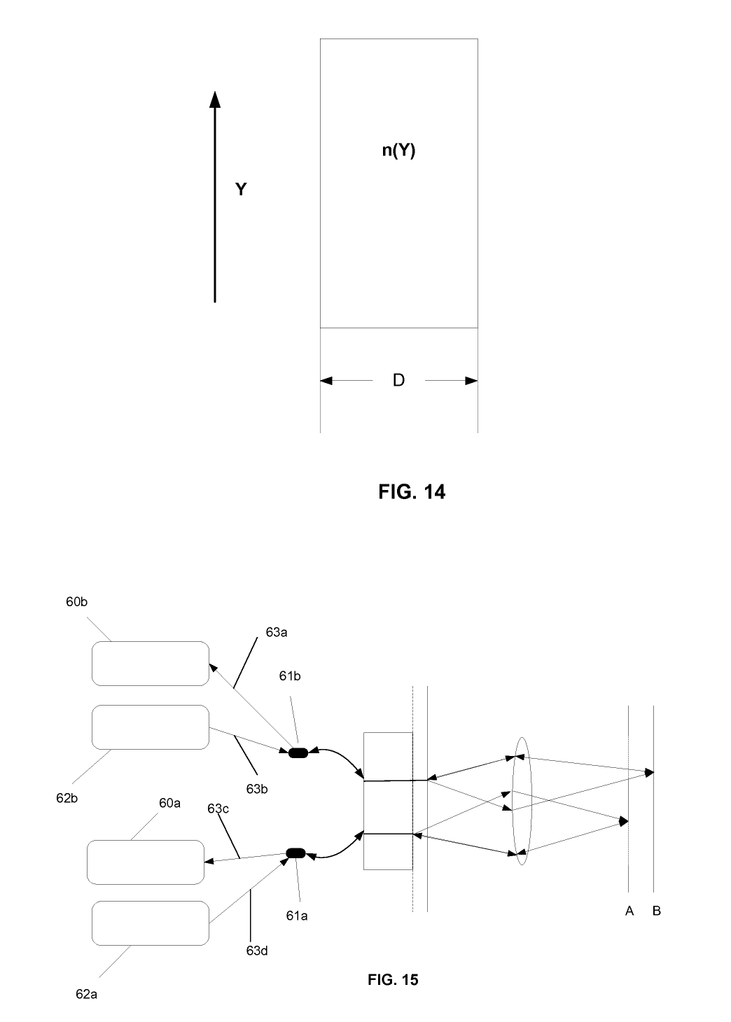

An example of the concept is shown in FIG. 15. Optical detectors 60a and 60b, are optically coupled to laser diodes 62a, 62b by fiber optic couplers 61a and 61b and optical fibers 63a through 63d, respectively. The laser radiation that impinges on the printing plate is partially reflected backwards and detected by optical detectors 60a and 60b. The signal at optical detector 60a, V1, and the signal at optical detector 60b, V2, are proportional to the position of the printing plate. When the plate is in position A the signal at optical detector 60a will be at its maximum value, and when the plate is in position B, the signal at optical detector 60b will be at its maximum value. Hence, signals V1 and V2 can be used to adjust the imaging lens at a desired distance relative to the position of the printing plate. Furthermore, the signals V1 and V2 can be used to inspect and diagnose the printing plate after or during the exposure to the laser beam.

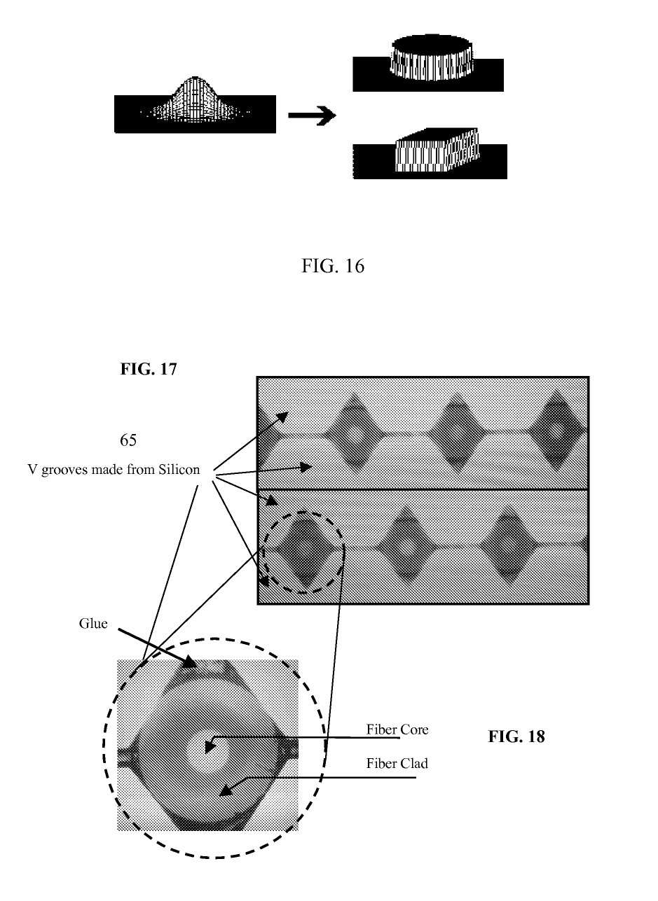

When a single mode diode is used, the Gaussian profile of the beam can be converted, utilizing diffractive optic elements, to be top hat, as depicted in FIG. 16 Such diffractive elements are made by several companies, including: www.holoor.co.il/website/data/index.html.

The light source described by FIGS. 1-16 can be a diode laser and/or a fiber coupled diode laser. The different configurations in which the fibers are aligned relative to each other described by FIGS. 1-16 can be done relative to the slow and/or fast axis of the printing drum (the slow and fast axis are well known parameters to any one skilled in the printing art).

The fibers can be aligned in space in any configuration relative to each other; for example, in a mechanical support, such as a V-groove 65, shown in FIGS. 17 and 18. The fibers may be aligned one adjacent to the other and/or one above the other, where two or more V-grooves are aligned one on top of the other in a sandwich configuration. The specific case of a sandwich configuration can be seen in FIG. 17.

By using diodes at different wavelengths several advantages can be obtained for direct engraving. By a proper optical design the depth of focus can be increased while keeping a relative good spot size which will fit the direct engraving quality.

The diodes can be spatially (by using fibers with different core diameters, or by positioning the distal tips of the fibers at different object planes) and/or temporally modulated relative to each other in order to get different effects on the direct engraving plate. For example, by initiating the first diode before the second diode, etc.

When using laser diodes which emit light at different wavelengths, the multi color light source can be tailored to the special optical and thermal characteristics of a direct engraving printing plate, such as the printing plate described in commonly-assigned copending U.S. patent application Ser. No. 11/353,217.

The advantages of the present invention are:

Increasing both the power and depth of focus while keeping a relatively good spot size which will be adequate for the quality needed for direct engraving.

The lasers can be temporally modulated, simultaneously or relative to each other in order to get a better thermal effect on special engraving plates.

Direct modulation of the lasers does not require external modulation.

The invention has been described in detail with particular reference to certain preferred embodiments thereof, but it will be understood that variations and modifications can be effected within the spirit and scope of the invention.

### Parts List

10 laser diode
10a wavelength λ2 P polarization
10b wavelength λ2 S polarization
10c wavelength λ1 P polarization
10d wavelength λ1 S polarization
12 laser diode
16 imaging lens
18 focus point
20 focus point
22 beam combiner
24 polarization beam combiner
26 fiber optic coupler
27 polarization fiber-optic combiner
30a laser diode
30b laser diode
31 direction of head movement
32a laser diode
32b laser diode
33a optical fiber
33b optical fiber
35 V-groove
37 imaging lens
40a spot with 50 microns diameter
40b spot with 20 microns diameter
41a laser diode
41b laser diode
42a spot with 50 microns diameter
42b spot with 20 microns diameter
43a optical fiber
43b optical fiber
44 V-groove
45 object plane
46 object plane
47 image plane
48 image plane
50 glass plate
52 optical fiber
54 imaging lens
55 laser diode
60a optical detector
60b optical detector
61a fiber optic coupler
61b fiber optic coupler
62a laser diode
62b laser diode
63a optical fiber
63b optical fiber
63c optical fiber
63d optical fiber
65 V-groove

1. An optical imaging head for direct engraving of flexographic printing plates, comprising:
at least two laser diodes emitting radiation in one or more wavelengths; and
means for imaging said one or more wavelengths of radiation at different depths relative to a surface of said plate.

2. The optical imaging head of claim 1 wherein said laser diodes are fiber-coupled.

3. The optical imaging head of claim 1 wherein said means for imaging comprise a telecentric lens.

4. The optical imaging head of claim 1 wherein a non imaging optical element is used in front of the means for imaging.

5. The optical imaging head of claim 2 wherein said means for imaging comprise a telecentric lens.

6. The optical imaging head of claim 1 wherein said laser diodes are multi mode and/or single mode laser diodes.

7. The optical imaging head of claim 1 wherein said laser diodes are coupled using wavelength dependent beam combiners.

8. The optical imaging head of claim 1 wherein said laser diodes are coupled using polarization dependent beam combiners.

9. The optical imaging head of claim 1 comprising means to temporally modulate directly the lasers relative to each other.

10. The optical imaging head of claim 1 wherein said means for imaging comprise a glass plate in the optical path.

11. The optical imaging head of claim 1 wherein said means for imaging comprise dispersive optical elements.

12. The optical imaging head of claim 1 wherein said imaging at different depths relative to said plate surface is achieved by adjusting said diodes or a distal tip of said fibers in different object planes of a telecentric lens.

13. The optical imaging head of claim 1 wherein diffractive optic elements convert a Gaussian profile of the beam to a top hat shape.

14. The optical imaging head of claim 2 wherein said fiber coupled laser diodes are provided with different core diameters in order to engrave different size spots on said plate.

15. The optical imaging head of claim 1 wherein at least part of said diodes are aligned in a common object plane of a telecentric lens.

16. The optical imaging head of claim 1 wherein at least part of said diodes are aligned in different object plane of a telecentric lens.

17. The optical imaging head of claim 1 additionally comprising:
means to inspect and diagnose said printing plate after or during radiation.

18. The optical imaging head of claim 10 wherein said glass plate is constructed from several zones, each having a different thickness and different or same index of refraction.

19. The optical imaging head of claim 17 wherein said inspecting means comprise detectors and fiber-optical couplers to measure the back reflection from the plate.

20. A method of engraving flexographic printing plates comprising the steps of:
providing at least two laser diodes each emitting radiation in one or more wavelengths;
providing a printing plate comprising an ablatable layer wherein the ablatable layer is adapted to strongly absorb radiation of said one or more wavelength; and
imaging said one or more wavelengths radiation at a same or at different depths relative to a surface of said plate.

21. The method of claim 20 wherein said imaging is at a same or different spots on said printing plate.

22. The method of claim 20 wherein said laser diodes are fiber-coupled.

23. The method of claim 21 wherein said laser diodes are fiber-coupled.

24. The method of claim 22 wherein said fibers are provided with different core diameters, to engrave different size spots on said plate.

25. The method of claim 23 wherein said fibers are provided with different core diameters, to engrave different size spots on said plate.

26. The method of claim 22 wherein said imaging at different depths relative to said plate surface is achieved by adjusting at least part of said diodes or part of a distal tip of said fibers in different object planes of a telecentric lens.
